(19) United States
(12) Patent Application Publication
(10) Pub. No.: US 2019/0365133 A1
(43) Pub. Date: Dec. 5, 2019

(54) DEVICE AND METHOD OF DUAL COOKING OF FOWL USING A NEW ARTICLE OF MANUFACTURE

(71) Applicant: Ray F. Robbins, Talladega, AL (US)

(72) Inventor: Ray F. Robbins, Talladega, AL (US)

(21) Appl. No.: 15/996,475

(22) Filed: Jun. 2, 2018

(51) Int. Cl. A47J 27/00; A47J 43/18; A47J 27/10

(52) U.S. Cl. CPC A47J 27/002; A47J 27/10; A47J 43/18

(57) ABSTRACT

This invention generally relates to an article of manufacture for cooking fowl, comprising: a body portion having a bottom; a side wall; and a central cylinder connected to the bottom and open at the top, wherein, said article of manufacture is a single piece molded from cast iron. The article of manufacture is also contemplated having a flange connected to the outer margin of the side wall and a pouring lip or spout. One embodiment includes one or more flange(s) extending downward to the top of the side-wall, but not below the same. A second embodiment of the article of manufacture includes a cover, wherein the cover forms a convection cooking chamber when used together with the article of manufacture.

### RELATED APPLICATIONS

This application claims priority from U.S. Provisional Patent Application Ser. No. 62/514,433 Titled “A DEVICE AND METHOD OF DUAL COOKING OF FOWL USING A NEW ARTICLE OF MANUFACTURE,” filed on Jun. 2, 2017 having Ray Robbins listed as inventor.

### FEDERALLY SPONSORED RESEARCH

No federal funds were used in the development of the present invention.

### JOINT RESEARCH AGREEMENTS

Not Applicable.

### SEQUENCE LISTING

Not Applicable.

### BACKGROUND

Cooking a whole fowl (i.e. chickens, turkeys and similar fowl) on a barbeque grill, smoker, fire pit, or similar appliance is difficult and can lead to dry, overcooked and tasteless meat. The thickness of the fowl is disadvantageous for uniform cooking using heat that is applied directly to the outside of the fowl.

One common method to allow even cooking of fowl is called a Rotisserie. The Rotisserie style of roasting meat that is skewered on a spit—a long solid rod used to hold food while it is being cooked over a fire in a fireplace or over a campfire, or roasted in an oven. This method is generally used for cooking large joints of meat or entire animals, such as pigs or turkeys. The rotation cooks the meat evenly in its own juices and allows easy access for continuous self-basting.

The present invention overcomes the disadvantages of evenly cooking a large fowl without the additional hassle and cost to purchase and use electric motors for a spit by providing a dual type-cooking skillet device. A first embodiment of the dual type-cooking skillet comprises a shallow culinary vessel of cast-iron provided with a pouring spout or lip and a central hollow cylinder protruding above the outer vessel walls. The central hollow cylinder is open on top and closed on the bottom and capable of being filled with a liquid, wherein the fowl can be placed on the central hollow cylinder allowing dual (inside and outside) cooking. The central hollow cylinder can accommodate a can of beer or another seasoning liquid used to internally and uniformly cook and/or marinade the fowl from the inside.

More specifically, the preferred fowl of this invention is a chicken that weighs about 3½ to 5 pounds. The outer portion of the fowl is rubbed with oil and spices. The wings are folded back to prevent burning and a seasoning liquid is pored into the central hollow cylinder. The posterior of the fowl is placed over the central hollow cylinder, wherein the fowl sits on three points, the central hollow cylinder and the two drumsticks. The entire dual type-cooking skillet of this invention is placed over indirect heat in a 2-zone system so it can cook by convection heat on the outside and the boiling liquid on the inside of the fowl. Because the invention is made from cast iron, the dual type-cooking system can even be placed directly over the heat source without having the lower section of the fowl cooking faster than the upper section. Using both heating/cooking techniques, one skilled in the art of roasting fowl usually does not need to turn the bird to have it cooked completely. Using the invention, one can experience a evenly roasted fowl having the following attributes:
Crackly skin being crunchy, tasty and having reduced fat, wherein the vertical orientation drains fat well.
Even exterior browning is experienced because there is no need to tie the legs together as is done in the classic French roast method, wherein the crotch area browns better than when the meat is trussed.
The dual type-cooking skillet of this invention cooks white meat and dark meat to proper temps. Breasts should be removed at about 160° F. and dark meat is best in the 170° F. to 180° F. range, wherein vertical roasting using said invention with the legs closer to the bottom of the invention allows the dark meat finish cooking at about the same time the breasts are completed.

In contrast, if a fowl is cooked without the device of this invention and is placed directly over the heat, a cremated fowl will be expected since fat drips out the bottom and the direct heat cooks the bottom far faster than the breasts.

A person having ordinary skill in the arts that are encompassed will appreciate that modifications of the device can be made without departing from the spirit of the invention or defined by the scope of the claims.

### SUMMARY

One aspect of the current invention is an article of manufacture comprising: a body portion having a bottom; a side wall; and a central cylinder connected to the bottom and open at the top, wherein, said article of manufacture is a single item molded from cast iron. The article of manufacture is also contemplated having at least one flange connected to the outer margin of the side wall and a pouring lip or spout. One embodiment of the article of manufacture includes a cover, wherein the cover forms a convection-cooking chamber when used together with the article of manufacture to allow even cooking of a fowl when a two-zone cooking apparatus is unavailable.

### BRIEF DESCRIPTION OF THE DRAWINGS

FIG. 1 shows a perspective view of the device with the liquid reservoir located therein, the liquid reservoir is capable of holding a can of beer.

FIG. 2 shows a side view of the device.

FIG. 3 shows a top view of the device.

FIG. 4 shows a bottom view of the device.

FIG. 5 shows a fowl supported upright on the device with the hollow cylinder in the abdomen of the fowl.

FIG. 6 shows a side view of a fowl supported upright on the device with the hollow cylinder in the abdomen of the fowl and a cover.

### DETAILED DESCRIPTION OF THE PREFERRED EMBODIMENTS

It will be readily apparent to one skilled in the art that various substitutions and modifications may be made in the invention disclosed herein without departing from the scope and spirit of the invention.

The term “a” or “an” as used herein in the specification may mean one or more. As used herein in the claim(s), when used in conjunction with the word “comprising”, the words “a” or “an” may mean one or more than one. As used herein “another” may mean at least a second or more.

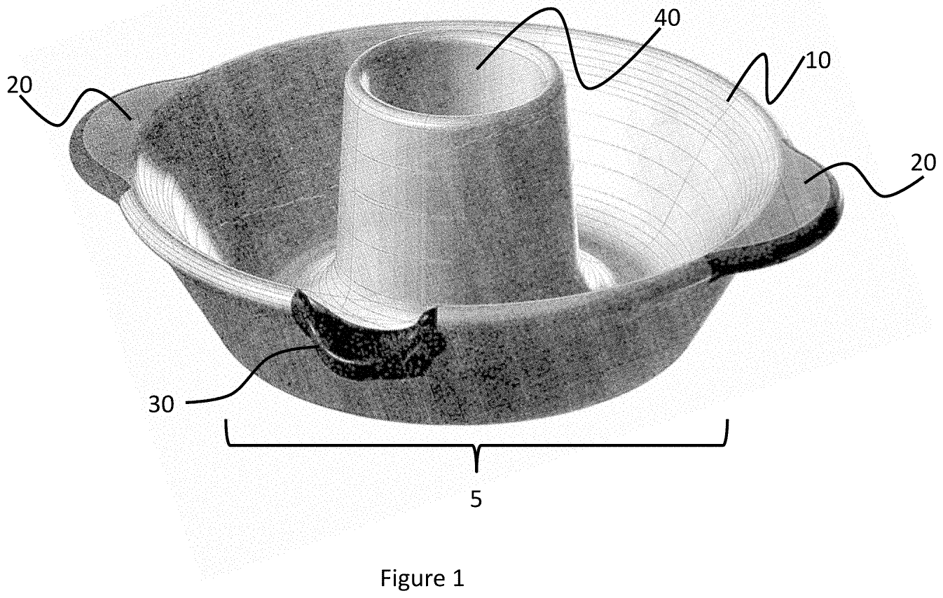

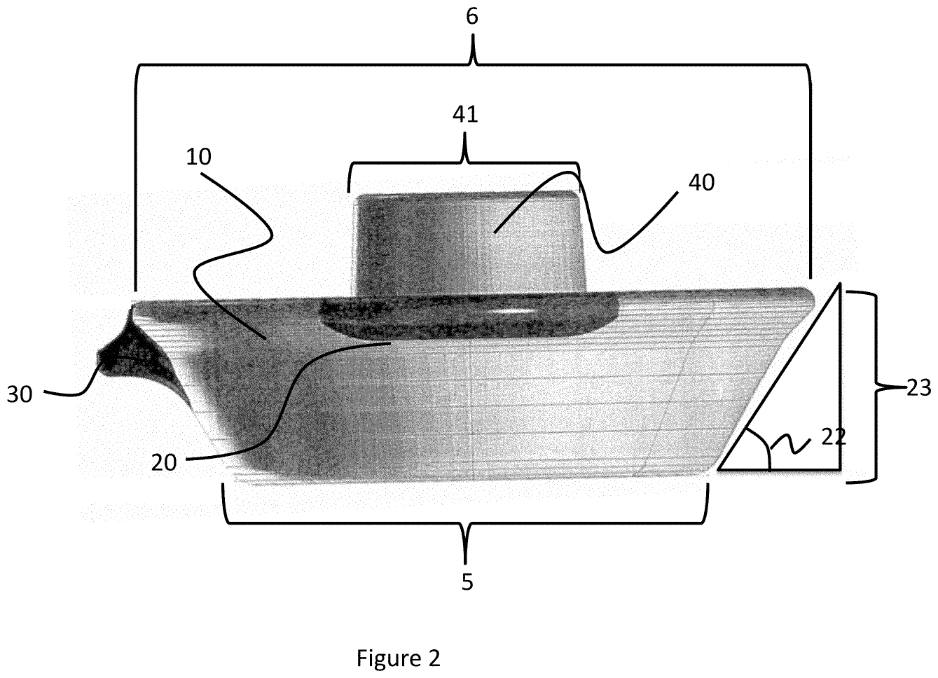

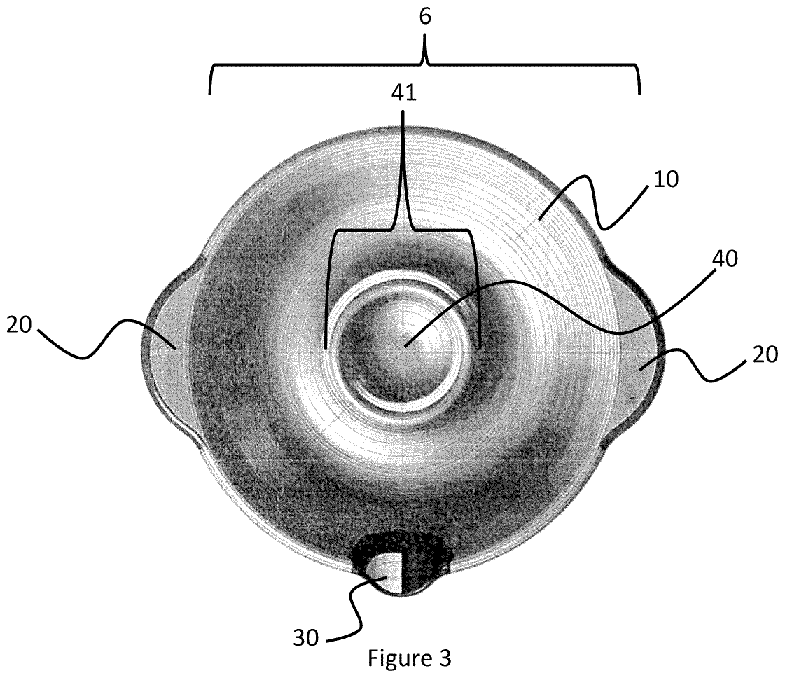

Fowl, such as turkeys and chickens are typically prepared for cooking to include an opening leading to an internal abdominal cavity that is often stuffed with seasonings or other condiments. Referring now to FIGS. 1 through 5, the present invention relates to an article of manufacture of a dual type-cooking skillet device having a hollow cylindrical device used for supporting and steaming such fowl 60. FIG. 1 shows a perspective view of the device comprising a substantially circular base 5 having sidewalls 10, flange handles 20, a pouring lip 30, and a central hollow cylinder 40. Upwardly extending from the top surface of the base member is a hollow interior chamber 40, which is open top and capable of holding a liquid. The hollow interior chamber is dimensioned to be tightly received within the opening and the abdominal cavity of a fowl. FIG. 2 shows a side view of the device having a diameter of the circular base 5 in the range of about 4.5-7.5 inches and the sidewalls 10 having an opening 6 in the range of about 8.0-11.0 inches. The hollow interior chamber 40 has a diameter 41 in the range of about 2.5-3.5 inches and the upper portion of the chamber 40 is elevated above the sidewalls 10 in the range of about 1.0 to 2.0 inches, as shown in the side view of FIG. 2. FIG. 3 shows a top view of the device having a diameter of the circular base 5 in the range of about 4.5-7.5 inches and the sidewalls 10 having an opening 6 in the range of about 8.0-11.0 inches. Additionally, FIG. 3 shows the hollow interior chamber 40 having a diameter 41 in the range of about 2.5-3.5 inches.

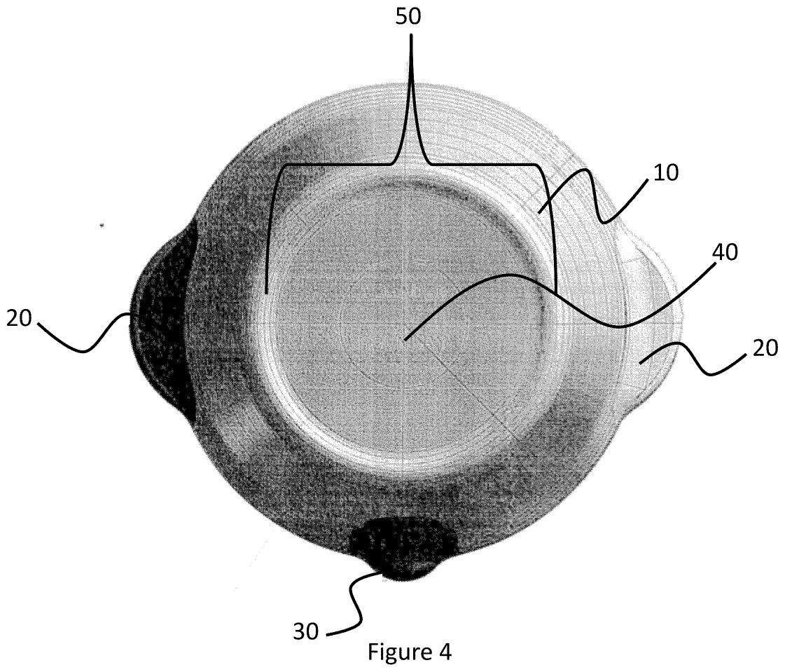

FIG. 4 shows a bottom view of the device having a diameter of the circular base 5 in the range of about 4.5-7.5 inches and the sidewalls 10 having a width diameter in the range of about 8.0-11.0 inches. FIG. 4 also shows flange handles 20 and a pouring lip 30.

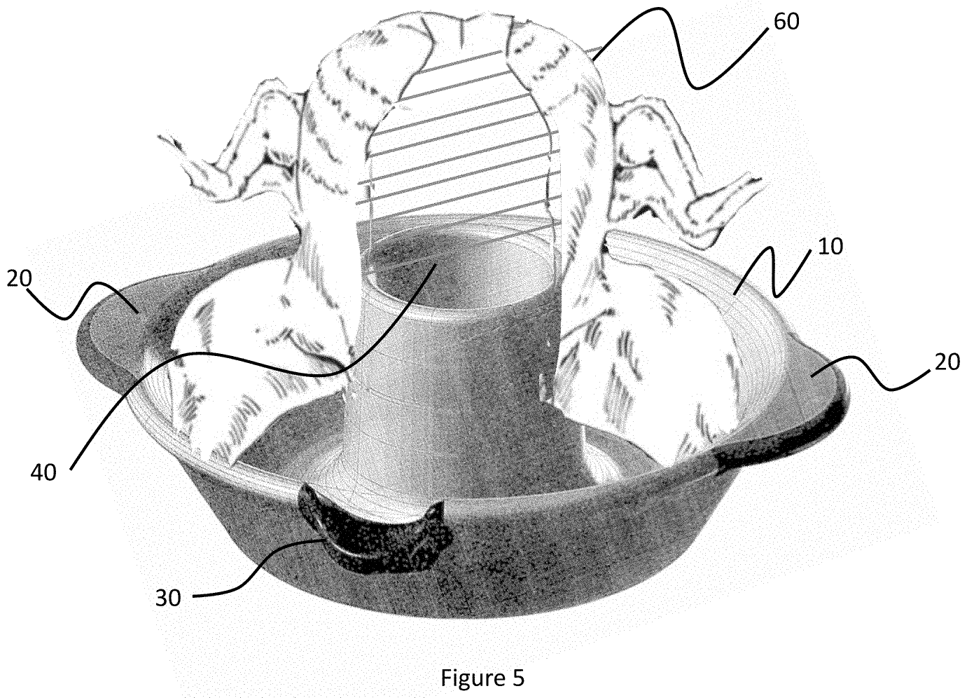

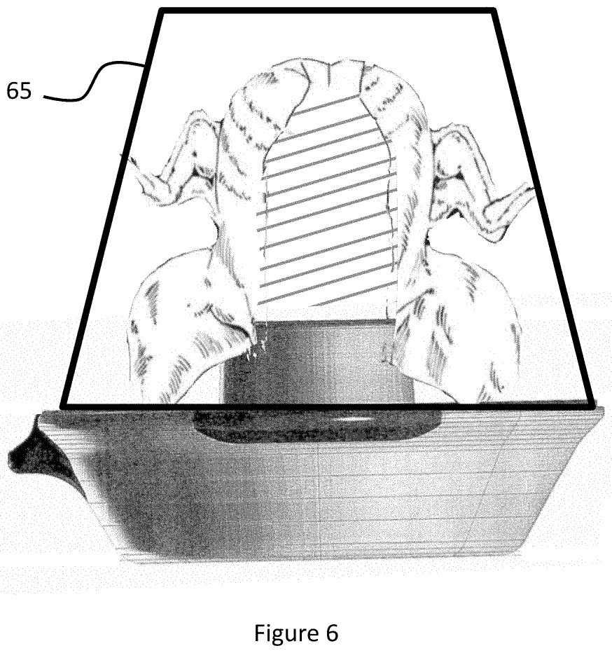

FIG. 5 shows an image of how to place a fowl on the above-described device, a user places a desired fluid, such as water or a marinade into the interior hollow chamber 40 of the article of manufacture. The abdominal cavity of the fowl 60 is placed over the interior hollow chamber 40. FIG. 5 shows the breast of the fowl cut away only to view the placement on the device. The base member is then placed on a smoker, grill or other horizontal cooking surface to support the fowl in an upright position as depicted in FIG. 5. As the fluid within the interior chamber is heated to a predetermined temperature, steam is produced and dispensed directly into the abdominal cavity of the fowl thereby preventing the fowl from drying. Alternatively, a detachable cover (See FIG. 6) can be placed over the fowl to promote outside convection heating if a covered smoker or grill is unavailable. The cover of FIG. 6 allows a fowl to be cooked in the device over an open flame such a campfire.

The article of manufacture, as described above, is preferably constructed with cast iron. However, as will be readily apparent to those skilled in the art, the size, shape and materials of construction may be varied without departing from the spirit of the present invention. The cover of FIG. 6 can be constructed from the same or different material as the article of manufacture.

### EXAMPLES

The following examples are included to demonstrate preferred embodiments of the invention. It should be appreciated by those of skill in the art that the techniques disclosed in the examples that follow represent techniques discovered by the inventor to function well in the practice of the invention, and thus can be considered to constitute preferred modes for its practice. However, those of skill in the art should, in light of the present disclosure, appreciate that many changes can be made in the specific embodiments that are disclosed and still obtain a like or similar result without departing from the spirit and scope of the invention.

### Example 1

An article of manufacture is visualized as a dual-type fowl-cooking device that includes several features. For example, the dual-type fowl-cooking device comprises bowl body portion having a substantially circular base bottom with a diameter in the range of 4.5-8.0 inches, as shown as 5 in FIG. 2. The substantially cylindrical side-walls are attached to the substantially circular base bottom and extending upwards and outwards from the base bottom to a height range of about 2.0-4.0 inches, as shown as 23 in FIG. 2. The upwards and outwards angle formed from the base to the rim is in the range of 45°-90°, as shown as 22 in FIG. 2. The side walls can extend upwards the substantially cylindrical side walls and base bottom forming a water-tight body bowl portion with an upper rim opening in the range of 8.0-11.0 inches (shown as 6 in FIG. 2). The hollow central cylinder is connected substantially perpendicular at a first end to the base bottom in a central location relative to the substantially cylindrical side wall, as shown as 40 in FIG. 2; a first end of the hollow central cylinder forms a water-tight chamber having the second end open at the top, the hollow central cylindrical having a diameter range of about 2.5-3.5 inches (as shown 41 in FIG. 2) and a length from the first end to the second end in a range of about 3.0-6.0 inches; the hollow central cylinder is used for supporting the fowl and holding liquid for steaming said fowl from the inside when liquid heated to cooking temperatures, as shown in FIG. 5. The dual-type fowl-cooking device may contain one or more flanges extending outward from the rim of the sidewall, as 20 in FIG. 5. A pouring lip or spout extending downward and outward from the rim of the sidewall is 30 in FIG. 5. The dual-type fowl-cooking device can be used alone or in combination with a detached cover, as 65 in FIG. 6. The detached cover comprises a conical bowl body portion having a substantially circular closed top end with a diameter in the range of 4.5-8.0 inches and the substantially conical side walls are attached to the substantially circular closed top end extending downwards from to a lower rim opening in the range of 8.0-11.0 inches, as 65 in FIG. 6. The detached cover allows convection cooking for the outside of a fowl being cooked inside the article of manufacture from a single heat source emanating from the bottom of dual-type fowl cooking device. This example of the dual-type fowl-cooking device is manufactured and molded from cast iron.

### Example 2

This example describes the device of FIG. 1 produced from cast iron. Cast iron is made by re-melting pig iron with substantial quantities of iron, steel, limestone, carbon (coke), wherein various steps are used to remove undesirable contaminants. For the current application, carbon and silicon content are adjusted to the desired levels in the range of about 2-3.5% and 1-3%, respectively. One having ordinary skill in the art understands that other elements can then added to the melt before the final form of the device is produced by casting without departing from the spirit and scope of the invention. After melting is complete, the molten cast iron is ready to be cast. In metalworking, casting means a process, in which liquid metal is poured into a mold, that contains a hollow cavity of the desired shape, and is then allowed to cool and solidify. The solidified part is also known as a casting, which is ejected or broken out of the mold to complete the process.

Casting is most often used for making complex shapes that would be difficult or uneconomical to make by other methods. The modern casting process is subdivided into two main categories: expendable and non-expendable casting. It is further broken down by the mold material, such as sand or metal, and pouring method, such as gravity, vacuum, or low pressure. The article of manufacture shown in FIGS. 1-5 can be cast by any of these methods.

### Example 3

A method of cooking a fowl using a dual-type fowl-cooking device of this invention is discussed. The first step is to clean the fowl as recommended for the fowl species. Once the fowl has been cleaned, the hollow central cylinder with a liquid, which may be any type of cooking compatible water based fluid (i.e. water, beer, wine, juices, extracts, etc). The fowl is then placed on the fowl cooking device by placing a posterior end of a fowl over the hollow central cylinder, as shown in FIG. 5. The entire device with the liquid and fowl is then heated a period of time in a closed heating unit (i.e. a conventional oven, a barbeque grill, a smoker grill or equivalent thereof). The period of cooking time depends on the size of the fowl. Typical periods of cooking times is not more than 3 hours, however if the fowl is to be consumed cooking should continue until the internal temperature of fowl reaches about 180° F.

### Example 4

A method of cooking a fowl using a dual-type fowl-cooking device of this invention is discussed. The first step is to clean the fowl as recommended for the fowl species. Once the fowl has been cleaned, the hollow central cylinder with a liquid, which may be any type of cooking compatible water based fluid (i.e. water, beer, wine, juices, extracts, etc). The fowl is then placed on the fowl cooking device by placing a posterior end of a fowl over the hollow central cylinder, as shown in FIG. 5. A detachable cover is then placed over the entire device with the liquid and fowl, as shown in FIG. 6. The entire device is then heated a period of time in an open heating source (i.e. wood burning campfire, gas campfire or equivalent thereof). The period of cooking time depends on the size of the fowl. Typical periods of cooking times is not more than 3 hours, however if the fowl is to be consumed cooking should continue until the internal temperature of fowl reaches about 180° F.

What is claimed is:

1. An article of manufacture of a dual-type fowl cooking device comprising:
a. a bowl body portion having a substantially circular base bottom with a diameter in the range of 4.5-8.0 inches;
b. a substantially cylindrical side walls attached to the substantially circular base bottom and extending upwards from the base bottom to a height in range of about 2.0-4.0 inches; the substantially cylindrical side walls and base bottom forming a water-tight body bowl portion with an upper rim opening in the range of 8.0-11.0 inches; and
c. a hollow central cylinder connected substantially perpendicular at a first end to the base bottom in a central location relative to the substantially cylindrical side wall; a first end of the hollow central cylinder forms a water-tight chamber having the second end open at the top, the hollow central cylindrical having a diameter range of about 2.5-3.5 inches and a length from the first end to the second end in a range of about 3.0-6.0 inches; the hollow central cylinder is used for supporting the fowl and holding liquid for steaming said fowl when heated;
wherein, said article of manufacture is molded from cast iron.

2. The article of manufacture of claim 1 further comprising:
d. a flange connected to the outer margin of the rim of the side wall and
e. a pouring lip or spout extending downward and outward from the rim of the sidewall;
wherein one or more of said flange extends outward from the rim of the side wall.

3. The article of manufacture of claim 1 further comprising:
f. a detached cover, wherein the detached cover comprises: a conical bowl body portion having a substantially circular closed top end with a diameter in the range of 4.5-8.0 inches; substantially conical side walls are attached to the substantially circular closed top end extending downwards from to a lower rim opening in the range of 8.0-11.0 inches;
wherein the detached cover allows convection cooking for the outside of a fowl being cooked inside the article of manufacture when using a single heat source emanating from the bottom of dual-type fowl cooking device.

4. A method of cooking a fowl using a dual-type fowl cooking device comprising:
a. filling the hollow central cylinder with a liquid;
b. placing a posterior end of a fowl over the hollow central cylinder;
c. heating the dual-type fowl cooking device with filling liquid and fowl for a period of time in a closed heating unit;
wherein the period of time until internal temperature of fowl reaches about 180° F.

5. The method of cooking a fowl from claim 4, further comprising:
d. using the closed heating unit having a bottom heating source;
wherein the closed heating unit having a bottom heating source comprises: an oven, a barbeque grill, a smoker grill or equivalent thereof.
